(19) United States
(12) Patent Application Publication
(10) Pub. No.: US 2010/0290031 A1
(43) Pub. Date: Nov. 18, 2010

(54) SPECTRAL ANALYSIS METHOD FOR DETERMINING CHLOROPHYLL CONCENTRATION

(76) Inventor: Wilhelm Luedeker, Windach (DE)

Correspondence Address: BOYLE FREDRICKSON S.C., 840 North Plankinton Avenue, MILWAUKEE, WI, 53203, US

(21) Appl. No.: 12/297,014

(22) PCT Filed: Apr. 13, 2007
(86) PCT No.: PCT/DE07/00647

§ 371 Date: Aug. 7, 2009

(30) Foreign Application Priority Data
Apr. 13, 2006 (DE) 10 2006 017 809.2

(51) Int. Cl. G01J 3/36; G01N 21/31; G01J 3/427

(52) U.S. Cl. 356/51; 356/319; 356/307

(57) ABSTRACT

The invention relates to a method and a device for determining a predefined spectral range, particularly the spectral range around the red edge. In said method, the analysis of the spectral range is carried out by means of two overlapping spectral value functions. The invention also relates to a method and a system for characterizing existent vegetation.

### BACKGROUND OF THE INVENTION

1. Field of the Invention

The present invention relates to a method and a device for analyzing a predefined spectral range as well as to a method and a system for characterizing existent vegetation.

2. Description of the Related Art

During analysis of narrow-band spectral reflection phenomena of objects the problem arises that, when the narrow-band phenomenon is to be detected as to quantity with sufficient accuracy, comparatively many spectrally or linearly independent sensors are required. For this purpose usually hyper spectral sensors (line detectors) are used which can continuously detect a spectral range of from 500 to 1000 nm. The spectral resolution of such devices generally ranges from 0.5 to 5 nm.

If moreover a high resolution of at least 0.5 nm is required, for instance to determine displacements in the reflection of an object by few nanometers, plural measuring channels are necessary to provide the required covering of the spectral range. It is further a drawback that due to the required narrow-band recording the exposure times or the integration times become very long so that only static or quasi-static measurements can be made. Dynamic measurements, such as for instance measuring an area by tracking it by a detector, are therefore almost excluded and, if they are still carried out, they are loaded with a very high noise level.

In addition, the reflection phenomenon subject to examination has to be filtered out of a plurality of spectral information, which means a great processing effort and thus a dynamic or real time analysis is not possible with a reasonable cost-benefit effort.

A further problem resides in the fact that the mere spectral analysis has to be explicitly derived from the radiometric analysis data. Moreover, disturbing variables such as different lighting conditions, for instance, have to be filtered out.

This problem exists especially when analyzing vegetation characteristics by determining the variation of the existing chlorophyll concentration within an examined range. Said variation of the chlorophyll concentration is in relation to a displacement of the red edge, as it is called, in the reflection spectrum of green plants, which results from the transition range from the very strong absorption bands of chlorophyll within the range of 660 nm and to the absorption-free spectral range above a wavelength of 700 nm. The displacement of the red edge is only few nanometers, wherein the related variation of the chlorophyll concentration can be very distinct. As, with the aid of said spectral data, especially the vegetation of large-scale agricultural areas which are covered by vehicles, especially tractors, is to be determined, a method and a device are necessary which allow for an cost-effective dynamic area measurement.

Therefore, it is the object of the present invention to provide a method and a device for spectral analysis of a predetermined spectral range which allow for both static and dynamic determinations of the predefined spectral range.

### SUMMARY OF INVENTION

A method for spectral analysis of a predefined spectral range, a device for spectral analysis of a predefined spectral range, as well as a vegetation characterizing method and a vegetation characterizing system according to the claims.

The present invention is based on the finding that by the analysis with at least two overlapping spectral value functions no longer numerous narrow-band independent wavelength bands having comparably long exposure times or integration times have to be taken, but it is sufficient to make use of broadband spectral functions.

In so doing, the same principle is used by which the human eye is enabled to resolve 10,000 different colors by only three or four different receptors. In the human eye even a spectral range of several hundreds of nanometers is covered, while in the spectral range subject to examination here only a narrow-band range of less than a hundred nanometers has to be examined.

For the analysis itself, two spectral value functions which are overlapping are determined analogously to the receptors of the eye. This can be implemented, for instance, by appropriate filters which are connected ahead of a detector or detectors. The measuring signals detected by the detectors then correspond to the determined spectral value functions. An embodiment in which the overlapping spectral ranges of the spectral value functions cover the spectral range to be examined by their intersection is especially advantageous in this context.

In order to counter an impurity of the signal by noise, the radiant power of a measuring channel can be determined via the integral of the spectral value function within the range of the predefined spectral range, as a particularly preferred embodiment shows. An embodiment in which the measuring signals defined by the spectral value function are picked up statically or dynamically is especially advantageous. For this purpose the measuring signals can be determined by means of point measurement or else by area measurement.

In order to carry out the method according to the invention, it is particularly preferred to make use of a device in which a measuring head having at least one detector and measuring optics is provided by which the measuring signals can be recorded advantageously via filters defining the spectral value functions. The filters can be alternately introduced in the focal plane of the detector, but it is also possible to make use of two detectors with a filter being connected ahead of each of them. The filters can be disposed either ahead of the measuring optics or directly ahead of the detector itself. It is moreover possible to form the filters integrally with the detector or the measuring optics.

As an alternative, as is shown by a further preferred embodiment, also two measuring heads can be used which record the measuring signals corresponding to the predefined spectral value functions.

The detector/detectors preferably can be in the form of a photodiode single detector, diode array (line detector) and/or focal plain array.

Moreover, the device according to the invention can have a storage unit for storing the measuring signals and a possibility for communication with a GPS device so that the measuring signals can be cartographically determined for an area.

It is further advantageous when the device according to the invention includes a sensor determining a radiant power of the ambient light. Thus disturbing influences existing by different types of lighting can be eliminated.

In order to minimize the disturbing influences by different lighting, it is moreover advantageous, if, as a preferred embodiment shows, furthermore a light source is provided which actively illuminates the range to be analyzed or the reflection spectrum of the object to be analyzed.

It is especially advantageous when the device according to the invention and the method according to the invention are used for characterizing vegetation stands. The spectral range to be examined is preferably put within the range of the so-called red edge which defines the transition from strong absorption to absorption-free ranges in the chlorophyll spectrum. By means of the position of the red edge it is possible to determine chlorophyll concentrations. The position of the red edge varies in relation to the amount of chlorophyll concentration. This is based on the fact that sound vegetation reflects relatively little radiation in the visible spectral range and relatively much radiation in the subsequent near infrared range. Other surface materials such as soil, rock or else dead or non-chlorophyll containing vegetation do not show such a characterizing difference of the degree of reflection of both ranges. Consequently, this fact can serve for distinguishing areas covered with vegetation from those not covered with vegetation.

It is especially advantageous when the overlapping spectral value functions cover the range of between 600 nm and 800 nm, their intersecting range lying within the range of between 650 and 700 nm.

An embodiment in which the device according to the invention can be mounted to a vehicle, especially a tractor, in order to be able to determine also large-scale vegetation, such as arable areas for instance, is especially advantageous.

These, and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

Hereinafter the invention is to be described in detail by way of figures. The embodiments shown in the figures are merely exemplary and are not to be used for restricting the scope of protection in this respect,

wherein:

FIG. 1 schematically shows the reflection spectrum of chlorophyll with the red edge arranged there;

FIG. 2 shows a first embodiment for the overlapping of two spectral value functions within the range of the red edge;

FIG. 3 shows a first embodiment of a device according to the invention for picking up two spectral functions;

FIG. 4 shows a second embodiment of the device according to the invention for picking up two spectral functions; and

FIG. 5 shows a third embodiment of the device according to the invention for picking up two spectral functions.

### DETAILED DESCRIPTION OF THE DRAWINGS

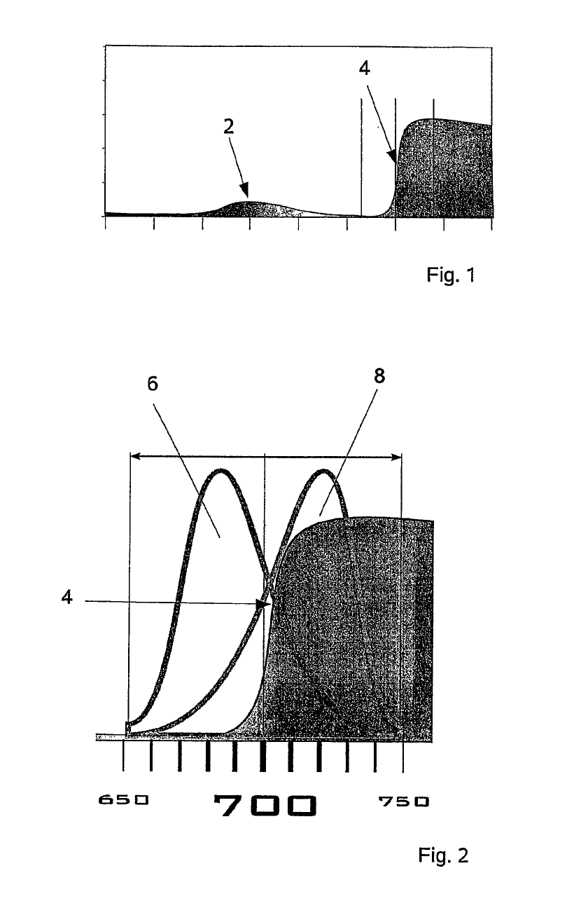

FIG. 1 shows the reflection spectrum of green plants, i.e. the absorption spectrum of chlorophyll. Over the visible range of 400 to approx. 700 nm of the human eye, chlorophyll shows a distinct absorption except for a range, here marked by reference number 2, at 550 nm, which is why plants appear green. The end of absorption is equally represented at approx. 700 nm the so-called red edge above which chlorophyll shows no absorption seen in terms of wavelength. The red edge is marked by reference number 4.

FIG. 2 shows a section of the reflection spectrum around the range of the red edge 4 from 650 to 750 nm. Moreover it is shown in FIG. 2 which exemplary spectral ranges could cover two spectral value functions 6 and 8 in order to examine the range of the red edge. It can be clearly seen that the red edge preferably lies in the intersecting range at the overlapping spectral value functions 6 and 8. In this “artificial” color space defined by the two fixed spectral value functions a modification/displacement in the spectrum is transformed into a corresponding displacement in the signal relations by the fact that the spectral characteristics of the phenomenon to be examined, such as for instance the red edge, act on both measuring signals defined by the spectral value functions. Depending on the position of the spectral ranges of the spectral value functions, the exact spectral position of the red edge can be gathered.

An impurity of the signal by noise can be minimized by the fact that the integral is formed via the spectral value function. The integration limits are selected such that they cover the possible range within which the red edge is positioned. This is mathematically determined by the following formula:

Sₓ(λ)=k*lₒ(λ)*ρ(λ)*x(λ) [1]

S_{y}(λ)=k*lₒ(λ)*ρ(λ)*y(λ) [2]

wherein:

S_{x/y}(λ)=spectral signal output in channel “x” (according to [1] or “y” (according to [2])

k=constant for detecting the electronic signal output (device function).

lₒ(λ)=spectral (solar) radiation power

ρ(λ)=spectral reflection coefficient (cf. picture 1)

x/y(λ)=spectral value function in channel “x” or “y” (cf. picture 2)

The signal outputs in the channels “x” and “y” (according to the presented method) result from the “defined” integration of λ₁ to λ₂, wherein λ₁, λ₂ are selected such that the red edge lies within the spectral range set up by λ₁ and λ₂:

$$\begin{matrix}{S}_{x} = {k}^{*} {\int }_{{λ}_{1}}^{{λ}_{2}} {l}_{o} ( λ ) {ρ ( λ )}^{*} {x ( λ )}^{*} d λ & [ 3 ] \\ {S}_{γ} = {k}^{*} {\int }_{{λ}_{1}}^{{λ}_{2}} {l}_{o} ( λ ) {ρ ( λ )}^{*} {y ( λ )}^{*} d λ & [ 4 ]\end{matrix}$$

By definition of the relevant spectral range λ₁ and λ₂ for the integral also disturbing influences such as ambient light variations, for instance, are reduced to the spectral range around the red edge. Especially the influence by “fair clouds” or “bright sky” is minimized or completely faded out.

As the position of the red edge is determined via the radiant power inside the channels, a complicated processing of the measuring results is unnecessary, because the integration is contained in the measuring principle already intrinsically.

For picking up the measuring signals defined by the spectral value function plural devices are possible. Basically, however, two measuring signals have to be picked up, wherein this can be realized by two measuring heads each having a detector. It is also possible, however, to use one single measuring head having one single detector in which the two measuring signals can be realized one after the other, for instance via different successively introduced filters. Moreover, it is possible to make use of a measuring head having two detectors or to arrange the filters on a detector such that two measuring signals corresponding to the fixed spectral value functions can be picked up. The devices can be used both for point measurement and for area measurement. It is basically applicable, however, that the observation of a measuring point in two channels at the same measuring time is possible only in a mono-static and biaxial manner, wherein each other method results in a time shift of the measuring spots.

Whether it is measured simultaneously (two detectors) or time-shifted (one detector), depends on the specific measuring tasks. Static measurements can be carried out both simultaneously and successively. However, in the case of dynamic measurements the dynamic range of the measured object has to be taken into account in the case of time-shifted measurements.

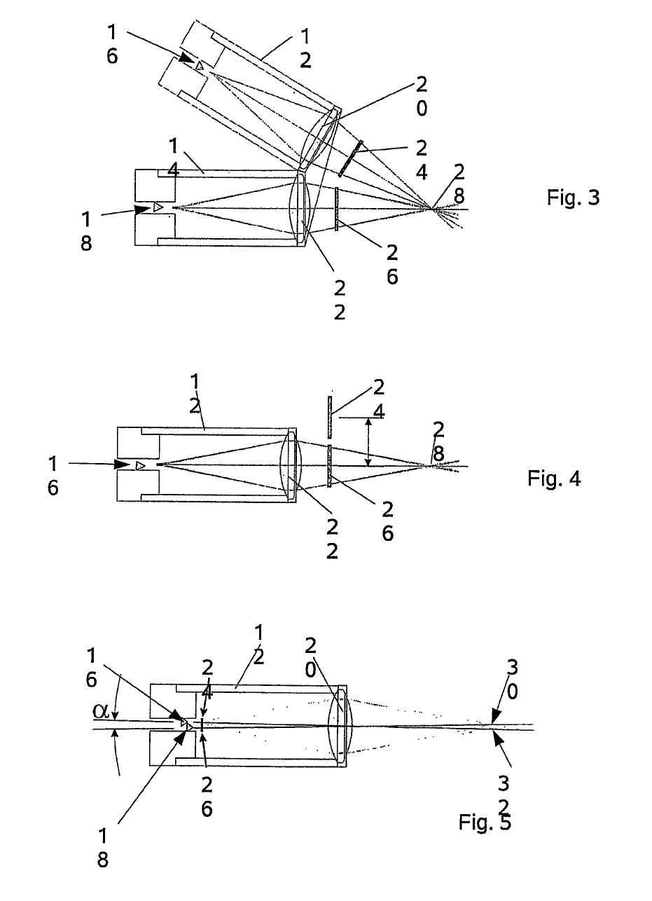

FIG. 3 shows a first preferred embodiment of the present invention in which the measurement of the spectral value function is carried out by means of two measuring heads 12, 14. The measuring heads 12, 14 have respective detectors 16, 18 and an optical means-represented as lenses 20, 22 here. The detector 16 disposed in the first measuring head 12 picks up a first measuring signal defined by a first spectral value function, while the detector 18 disposed in the second measuring head 14 picks up a second measuring signal defined by a second spectral value function. For defining the first and second spectral value functions filters 24, 26 for defining the range of the spectral value functions can be arranged ahead of the measuring heads 12 and/or 14. Both measuring heads 12, 14 focus the same point of an object 28. For taking up the spectral reflections of the object 28 moreover active lighting units, not shown here, can be provided which bring about a defined reflection. In addition, further sensors can be provided at the measuring heads 12, 14 which analyze the ambient light.

FIG. 4 shows a principal representation of a device according to the invention for time-shifted measurement of measuring signals defined by the spectral value functions. For this purpose, only one measuring head 12 having only one detector 16 is used, wherein again two filters 24, 26 defining the spectral value functions are provided which can alternately be introduced into the path of rays between the object 28 to be examined and the detector 16 so that at a first point in time t1 the measuring signal defined by the first spectral value function and/or the first filter 24 is picked up, while at a second point in time t2 the measuring signal defined by the second spectral value function and/or the second filter 26 is picked up.

Again both measurements of the same point 28 are made on one object. The set of filters 24 and 26 can alternately be introduced or rotate ahead of the measuring optics 20 or alternatively directly ahead of the detector 16.

Another possibility of picking up measuring signals corresponding to two spectral value functions is shown in FIG. 5. In the focal plane of one single measuring head 12 two detectors 16, 18 are arranged instead of one detector, as shown in FIG. 4. On principle, it is also possible, however, to divide the path of rays by means of mirrors so that the two detectors 16, 18 are arranged at an angle with respect to each other and one respective ray is guided to the detector 16 and another ray is guided to the detector 18.

FIG. 5 shows a variant without additional mirror, however, in which in the focal plane of the measuring optics 20 two filters 24, 26 are arranged the radiation of which is received in turn by two detectors 16, 18. In this measuring device at a first point in time t1 a first measuring signal is picked up by a filter 24 from an object point 30 and a second measuring signal is picked up by the filter 26 from an object point 32. In order to be able to carry out an analysis again by means of overlapping spectral value functions, however, the object points 30 and/or 32 have to be exactly picked up once again by the other filter. That is to say, at a second point in time t2 from the object spot 32 a measuring signal has to be picked up by the filter 28 and from the object spot 32 a measuring signal has to be picked up by the filter 26. To this effect, either the measuring head 12 or the detectors 16, 18 can be tilted about an angle α. However, it is also possible not to tilt the measuring head, but to displace it in total by the offset between the object points 30 and 32.

Basically, by each of the devices described in the FIGS. 3 to 5 also a dynamic measurement would be possible, but such measurement by two measuring heads, as described in FIG. 3, requires great mechanical effort and is very complex with respect to optical adjustment and dimensional stability.

For dynamic measurements therefore especially the device described in FIG. 5 is suited, because in this case merely the exposure times and durations of the two channels have to be synchronized with the dynamic image displacement by the object movement. This means that the direction of movement of the object has to have the same orientation as the detector arrangement in the focal plane. Thus the same object point 30 is depicted at the point in time t1 on the detector 16 and at the point in time t2 on the detector 18.

Although the device shown in FIG. 4 is relatively inappropriate for dynamic measurements, the mechanical effort is little for static measurements, however, and synchronizing of the filter closure time can be easily solved electronically by a timing of the detector cycles. In dynamic measurements a mechanical system which moves the entire apparatus has to be provided, however.

If not only point measurements but area measurements have to be carried out, instead of the single detectors shown here a diode array or focal plane array can be employed. In dynamic measurements which are carried out especially by the device shown in FIG. 5 the two detectors arranged in the focal plane can be preferably replaced by two diode arrays which show an orientation transversely to the direction of movement. By continuous movement in one direction thus a continuous picture composition is resulting which analyzes the spectral range over the measured area.

This is especially preferred when characterizing vegetation stands with the aid of determining the chlorophyll concentration by means of the position of the red edge. In this context, two cases are distinguished:

In the case of a closed vegetation stand the position of the red edge of vegetation is detected all over the area. As the position of the red edge in the spectrum in a first approach correlates with the chlorophyll concentration, the relative variations of concentration can be recorded. To this end, it is assumed that for homogenous cultivated plant stands the leave geometry, the leave spreading coefficient and the stand spreading characteristic are homogenous. Depending on measuring results, for instance required amounts of fertilizer can be adapted.

The second case of vegetation characteristic is the open vegetation stand. By forming a mixed signal of plant reflection and soil reflection the so-called normalized difference vegetation index can be determined, by which the degree of plant cover of the farmland can be determined. The index is based on the fact that vegetation reflects relatively little radiation in the visible spectral range (wavelength of approx. 400 to 700 nm) and relatively much radiation in the subsequent near infrared range (wavelength of approx. 700 to 1300 nm).

Other surface materials, such as soil, rock or else dead or non-chlorophyll containing vegetation, show no such characterizing difference of the degree of reflection of both ranges. As a consequence, this fact can serve for distinguishing areas covered with vegetation from uncovered areas. Depending on the different measuring results, conclusions can be drawn also about the state of vegetation. These conclusions can in turn serve as a basis of fertilization or weed killing measures.

It is especially advantageous when the device in addition includes a signal detecting unit which is correlated with the recording of GPS data, whereby mapping of the measured spectral value functions over the area is possible. It is moreover of advantage when the irradiation power of the ambient light is monitored by a sensor mounted on the device, whereby it is possible to standardize the signals. Furthermore, the device can also have an active light source for measuring the spectral value functions, whereby measurements are also possible in the case of poor light conditions.

It is especially advantageous to carry out the measurements by means of a vehicle and/or a tractor coupled with a so-called Miniveg N-Sensor. The Miniveg-N data can likewise be used for standardizing the soil conditions, wherein data can also be obtained from large-scale farmlands.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

1. A method for spectral analysis, the method comprising:
determining a positional displacement of an absorption band edge of chlorophyll within a spectral range of between 600 nm and 800 nm, by means of spectral analysis, wherein at least two spectral value functions, the spectral ranges of which are overlapping, are evaluated for the analysis.

2. A method according to claim 1, wherein the spectral ranges of the spectral value functions are broadband and cover a range of up to 100 nm.

3. A method according to claim 1, wherein the radiant power is established in accordance with the spectral value functions via integration along the predefined spectral range.

4. A method according to claim 1, wherein the spectral analysis is determined either statically or dynamically.

5. A method according to claim 1, wherein the predefined spectral range is predefined by a reflection at an object subject to examination.

6. A method according to claim 1, wherein the spectral analysis is carried out by one of a point measurement and an area measurement.

7. A method according to claim 1, wherein the determining step is within a spectral range of between 650 nm and 750 nm.

8. A device for determining a positional displacement of an absorption band edge of chlorophyll in a spectral range of between 600 nm and 800 nm, in accordance with a method according to claim 1, wherein at least one measuring head is provided which includes at least one device for determining spectral value functions which determines two overlapping spectral value functions.

9. A device according to claim 8, wherein the measuring head has at least one detector and measuring optics.

10. A device according to claim 9, wherein the measuring head includes two detectors.

11. A device according to claim 8, wherein two measuring heads each having a detector and a device for determining spectral value functions are provided.

12. A device according to claim 8, wherein the device for determining spectral value functions is arranged ahead of at least one of the measuring optics and the at least one detector.

13. A device according to claim 8, wherein the device for determining the spectral value functions is realized by at least two filters.

14. A device according to claim 8, wherein the at least one detector is one of a group comprising a photodiode single detector, a diode array and a focal plane array.

15. A device according to claim 8, wherein a memory unit is provided in which a measuring signal detected by the at least one detector is stored.

16. A device according to claim 8, wherein the device has an interface via which at least one of a group comprising a memory unit and a GPS instrument can be addressed.

17. A device according to claim 8, wherein a sensor is provided by which a radiant power of ambient light is determined.

18. A device according to claim 8, wherein a light source for irradiating a range the spectral value function of which is to be determined is provided.

19. A vegetation characterizing method for identifying a vegetation characteristic, characterized in that a chlorophyll concentration characterizing the vegetation is determined by means of a method according to claim 1.

20. A method according to claim 19, wherein the chlorophyll concentration is determined via the spectral position of the red edge.

21. A method according to claim 19, wherein use is made of a device according to claim 8.

22. A vegetation characterizing system for determining a chlorophyll concentration characterizing the vegetation, wherein the chlorophyll concentration can be determined by a device according to claim 8.

23. A vegetation characterizing system according to claim 22, wherein the system is mounted to a vehicle.
